(19) United States
(12) Patent Application Publication
(10) Pub. No.: US 2014/0269456 A1
(43) Pub. Date: Sep. 18, 2014

(54) Method, an Apparatus and a Computer Program Product for Flexible TDD Configuration

(71) Applicants: Haiming Wang, Beijing (CN); Erlin Zeng, Beijing (CN); Chunyan Gao, Beijing (CN); Wei Hong, Beijing (CN); Jing Han, Beijing (CN); Tommi Koivisto, Espoo (FI); Matti Pikkarainen, Oulu (FI)

(72) Inventors: Haiming Wang, Beijing (CN); Erlin Zeng, Beijing (CN); Chunyan Gao, Beijing (CN); Wei Hong, Beijing (CN); Jing Han, Beijing (CN); Tommi Koivisto, Espoo (FI); Matti Pikkarainen, Oulu (FI)

(21) Appl. No.: 14/352,786

(22) PCT Filed: Oct. 20, 2011
(86) PCT No.: PCT/CN2011/081018

§ 371 Date: Apr. 18, 2014

(51) Int. Cl. H04W 28/04; H04L 5/14; H04W 72/08

(52) U.S. Cl. CPC H04W 28/048; H04W 72/082; H04L 5/14
USPC 370/280

(57) ABSTRACT

The invention relates to the radio interface between an apparatus for wireless communication and a network element, comprising flexible uplink/downlink configuration for time division duplex. The method comprises detecting a parameter indicating interference in a subframe of a time division duplex configuration; assigning a priority Physical Resource Block set for a flexible subframe; and scheduling the connection for a wireless apparatus according to the priority Physical Resource Block set.

### FIELD OF THE INVENTION

The invention relates to mobile communication networks. More specifically, the invention relates to the radio interface between an apparatus for wireless communication and a network element, comprising flexible uplink/downlink configuration for time division duplex.

### BACKGROUND OF THE INVENTION

Long Term Evolution (LTE) was introduced in release 8 of the 3^{rd} Generation Partnership Project (3GPP) which is a specification for the 3^{rd} generation mobile communication systems. LTE is a technique for mobile data transmission that aims to increase data transmission rates and decrease delays, among other things. 3GPP release 10 introduced a next version, LTE Advanced, fulfilling the 4^{th} generation system requirements.

Both LTE and LTE Advanced may utilize a technique called time division duplex (TDD) for separating the transmission directions from the user to the base station and back. In the TDD mode, the downlink and the uplink are on the same frequency and the separation occurs in the time domain, so that each direction in a connection is assigned to specific timeslots.

Herein, the term “downlink” (DL) is used to refer to the link from the base station to the mobile device or user equipment, and the term “uplink” (UL) is used to refer to the link from the mobile device or user equipment to the base station.

One benefit of the LTE TDD system is an asymmetric uplink-downlink allocation. This is obtained by providing seven different semi-statically configured uplink-downlink configurations. These allocations can provide from 40% to 90% of the DL subframes. The uplink-downlink configurations according to Table 4.2-2 of 3GPP specification TS 36.211 V10.2.0 (2011 June) are illustrated in FIG. 1.

The current specification proposal assumes the same TDD configuration in each cell to avoid interference between UL and DL either between two base stations or between two user equipments. However, in a local area (LA) network, due to a small number of active user equipments per cell, the traffic situation may fluctuate frequently. The TDD reconfiguration must adapt to the traffic to improve resource efficiency and provide power saving.

The 3GPP has agreed on a Study Item on “Study on further Enhancements to LTE TDD for DL-UL Interference Management and Traffic Adaptation”, reference RP-101450, to evaluate the gain from traffic adaptation based flexible TDD configuration, where each cell can (re)configure independent TDD configuration based on traffic in its own cell. Another objective is to study additional TDD DL-UL interference mitigation methods in multi-cell scenarios.

In case of flexible TDD configuration in each cell independently without coordination, the DL-UL interference problem will need to be considered. FIG. 2 illustrates the interference situation. The interference occurs for example where a femtocell is inside a macrocell and user equipments 100, 101 are located close to each other. Base stations 140, 150 cause interference to each other on the downlink control channel, as well as user equipments 100, 101 on the uplink channel. The interference appears in a subframe where the victim cell and aggressor cell configure different link directions. For example, in the LA network, the user equipment 101 has a similar transmission power as eNB, but the distance between user equipments 100, 101 can be smaller than the distance between the user equipment 101 and aggressor eNB 140. In this case, the interference from the UL data/control of aggressor cell user equipments 100 can degrade the performance of cell-edge DL user equipments 101 in the victim cell.

Another example is a heterogeneous network where the macro cell and femto cell adopt different TDD configurations. In this case, the DL transmission from the macro eNB 150 can cause significant interference to the femto cell due to the large transmission power at the macro eNB 150. In the example, the interference occurs between TDD DL-UL configurations 1 and 0, at subframes 4, wherein configuration 1 comprises subframes DSUUD and configuration 0 subframes DSUUU.

For an independent TDD configuration based on the traffic situation in each cell, the interference to the DL/UL data channel can be from the DL control/data from neighbouring eNBs or the UL control/data from neighbour cell user equipments. The DL-DL or UL-UL interference exists also in release 8 or release 10 where neighbouring cells are assumed to use the same TDD configuration. For such interference traditional mitigation methods may be used, e.g ICIC/eICIC, as known in releases 8 and 10 (Inter-Cell Interference Coordination/enhanced Inter-Cell Interference Coordination). For the data transmission in a flexible subframe, link adaptation and HARQ may also help adapting to the interference level.

Solutions proposed according to prior art to avoid or reduce interference from/to the data channel comprise muting the UL transmission in the flexible subframe or dynamic scheduling information exchange between eNBs. Muting the whole subframe may be too restrictive for a cell with a heavy load, while muting some Resource Elements (RE) or Physical Resource Blocks (PRB) based on scheduling in the neighbouring cell may require additional signalling between eNBs.

Frequency reuse for the inter-cell interference problem is known from documents US2009/0264077A1 and WO2011/041981A1. The information exchange on the frequency reuse can be done via X2 interface between eNBs or backhaul. To avoid additional signalling overhead, the frequency reservation in each cell can only be based on semi-static traffic and long-term statistics. One problem resulting from such design is not using efficiently the reserved resource, e.g. reserving too much resources in one cell and too little in another cell. If one cell borrows from another cell's reserved resource, the resource with less interference is not known. The information assisting in frequency reuse can also be obtained via a reported user equipment measurement. However, this introduces new requirements to the user equipment.

Frequency reuse applied to a flexible TDD scenario may generate additional problems. Flexible TDD configurations comprise fixed subframes with each cell using the same link direction and flexible subframes with different link directions. This situation may induce UL-UL/DL-DL or UL-DL/DL-UL interference in certain subframes. The UL-UL/DL-DL interference and the UL-DL/DL-UL interference are not considered separately in the resource reservation.

The DL-UL interference in flexible subframes may degrade the signal-to-noise-plus-interference ratio (SINR) significantly. The control signalling to be transmitted in the flexible subframe is more sensitive to the interference due to lack of Hybrid Automatic Repeat Request (HARQ), and it will further reduce the throughput. The lack of effective solution to this problem leads to inefficient resource utilization, especially in cells with a small number of users, where the traffic situation changes frequently.

### SUMMARY

The invention discloses a method for detecting a parameter indicating interference in a subframe of a time division duplex configuration; assigning a priority Physical Resource Block (PRB) set for a flexible subframe; and scheduling the connection for a wireless apparatus according to the priority Physical Resource Block set.

In one exemplary embodiment of the method the parameter indicating interference is indicating a wireless apparatus located further than a pre-defined distance from a serving base station. In one embodiment the distance is pre-defined to indicate a wireless apparatus located near the cell edge. For example, to the uplink subframes, cell edge wireless apparatuses are preferred to be scheduled in the priority Physical Resource Block set of the serving cell.

In one exemplary embodiment of the method the parameter indicating interference is a cell-specific reference signal, a Reference Signal Received Power (RSRP) or a Reference Signal Received Quality (RSRQ) or any combination of these.

In one exemplary embodiment the method comprises pre-defining the priority Physical Resource Block set in response to link direction, subframe index, cell identification or estimated cell load and pre-defining the priority order of Physical Resource Blocks within the priority Physical Resource Block set. In one exemplary embodiment the method comprises pre-defining the priority order in response to a radio frame index.

In one exemplary embodiment the method comprises setting the priority Physical Resource Block set in response to the Relative Narrowband Transmit Power (RNTP) indication or in response to the High Interference Indicator (HII).

In one exemplary embodiment the parameter indicating interference is a signaling indicating Physical Resource Blocks reserved for the flexible uplink subframe and the priority order of said Physical Resource Blocks.

The invention discloses also an apparatus for wireless communication comprising at least one processor and at least one memory comprising program code, wherein the at least one memory and the computer program code are configured to, with the at least one processor, cause the apparatus to detect a parameter indicating interference in a subframe of a time division duplex configuration; assign a priority Physical Resource Block set for a flexible subframe; and schedule the connection for a wireless apparatus according to the priority Physical Resource Block set.

In one exemplary embodiment the apparatus is configured to detect a wireless apparatus located further than a pre-defined distance from a serving base station as the parameter indicating interference.

In one exemplary embodiment the apparatus is configured to detect a cell-specific reference signal as the parameter indicating interference. In an embodiment said parameter is a Reference Signal Received Power or a Reference Signal Received Quality.

In one exemplary embodiment the apparatus is configured to assign the priority Physical Resource Block set in response to link direction, subframe index, cell identification or estimated cell load and to assign the priority order of Physical Resource Blocks within the priority Physical Resource Block set.

In one exemplary embodiment the apparatus is configured to assign the priority order in response to a radio frame index.

In one exemplary embodiment the apparatus is configured to set the priority Physical Resource Block set in response to the Relative Narrowband Transmit Power indication or in response to the High Interference Indicator.

In one exemplary embodiment the parameter indicating interference is a signaling indicating Physical Resource Blocks reserved for the flexible uplink subframe and the priority order of said Physical Resource Blocks.

In one exemplary embodiment the apparatus is configured to operate as a part of a network element. An example of a network element according to the present invention is an evolved Node B (eNB). The evolved Node B is a base station according to 3GPP LTE. 3GPP, the 3rd Generation Partnership Project, develops specifications for third generation mobile phone systems, and also from Release 8 (Rel-8) the next generation specifications often referred to as LTE, Long Term Evolution. The network element may also be a relay node, Donor evolved Node B (DeNB) or a similar element providing the functionality of a base station.

In one exemplary embodiment the wireless apparatus is configured to operate as a part of a user equipment. Examples of the user equipment are a mobile phone, a mobile computing device such as PDA, a laptop computer, a USB stick—basically any mobile device with wireless connectivity to a communication network.

The invention discloses also a computer program product comprising a computer-readable medium bearing computer program code embodied therein for use with a computer, the computer program code comprising: code for detecting a parameter indicating interference in a subframe of a time division duplex configuration; code for assigning a priority Physical Resource Block set for a flexible subframe; and code for scheduling the connection for a wireless apparatus according to the priority Physical Resource Block set.

In one exemplary embodiment the computer program product comprises code for the parameter indicating interference indicating a wireless apparatus located further than a pre-defined distance from a serving base station. In one exemplary embodiment the computer program product comprises code for the parameter indicating interference being a cell-specific reference signal. In one exemplary embodiment the computer program product comprises code for the parameter indicating interference being a Reference Signal Received Power or a Reference Signal Received Quality. In one exemplary embodiment the computer program product comprises code for pre-defining the priority Physical Resource Block set in response to link direction, subframe index, cell identification or estimated cell load and pre-defining the priority order of Physical Resource Blocks within the priority Physical Resource Block set.

In one exemplary embodiment the computer program product comprises code for pre-defining the priority order in response to a radio frame index. In one exemplary embodiment the computer program product comprises code for setting the priority Physical Resource Block set in response to the Relative Narrowband Transmit Power indication or in response to the High Interference Indicator. In one exemplary embodiment the computer program product comprises code for the parameter indicating interference being a signaling indicating Physical Resource Blocks reserved for the flexible uplink subframe and the priority order of said Physical Resource Blocks.

One benefit of the invention is utilizing currently specified feedback timing configurations and providing a model to select an effective TDD UL/DL configuration. The solution provides also backward compatibility with legacy user equipments, as minimum implementation and standardization efforts are introduced due to reusing most of the current mechanisms. The invention does not necessarily require dynamic signaling exchange between eNBs.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a table illustrating the TDD uplink-downlink configuration,

FIG. 2 is a diagram illustrating an example of interference between different elements,

FIG. 3 is a block diagram illustrating the elements according to the invention,

FIG. 4 illustrates one exemplary embodiment of variation within the priority PRB,

FIG. 5 illustrates one exemplary embodiment of predefined PRB set and the priority order,

FIG. 6 illustrates one exemplary embodiment according to the invention, and

FIG. 7 illustrates one exemplary embodiment of different feedback timings and pre-scheduling according to one TDD configuration.

### DETAILED DESCRIPTION OF THE INVENTION

Reference will now be made in detail to the embodiments of the present invention, examples of which are illustrated in the accompanying drawings.

FIG. 3 is a block diagram illustrating an apparatus for wireless communication 100 according to an embodiment connected to a mobile communication network. The apparatus 100 comprises at least one controller 110, such as a processor, a memory 120 and a communication interface 130. In one embodiment the apparatus is a computer chip. Stored in the memory 120 are computer instructions which are adapted to be executed on the processor 110. The communication interface 130 is adapted to receive and send information to and from the processor 110. The apparatus 100 is commonly referred to as a user equipment UE or it may comprise a part of a user equipment.

The base station 140 comprises at least one controller 141, such as a processor, a memory 142 and a communication interface 143. In one exemplary embodiment the base station 140 comprises a computer chip executing the functionality according to the invention. Stored in the memory 142 are computer instructions which are adapted to be executed on the processor 141. The communication interface 143 is adapted to receive and send information to and from the processor 141. The user equipment 100 is connected to the base station 140, the connection being formed by radio link 151. From the user equipment's 100 perspective the base station 140 offers the functionality required to connect to the wireless network.

The base station 140 is adapted to be part of a cellular radio access network such as E-UTRAN applying WCDMA technology or similar networks suitable for high speed data transmission. Such networks are often also referred to as 4G or LTE. In this example, the cellular radio access network supports carrier aggregation comprising LTE and HSPA. The base station 140 illustrated in FIG. 3 symbolizes all relevant network elements required to carry out the functionality of the wireless network. One example of the base station 140 is the evolved Node B, eNB. The wireless portion of the network operated by the base station is referred to as a cell; operations referred to be executed by the cell are executed by the base station. The downlink direction DL is defined as from the network 140 to the user equipment 100, and the uplink direction UL is defined as from the user equipment 100 to the network 140.

According to an embodiment of the invention, a priority PRB set is defined for UL and/or DL respectively in flexible subframes. In flexible UL subframes, cell-edge user equipments are preferred to be scheduled in the priority PRB set of its serving cell. In flexible DL subframes DL data transmission with large coverage, such as PDSCH (Physical Downlink Shared Channel) to cell edge user equipments and PDSCH to be detected with CRS (Cell-specific Reference Symbol or Common Reference Symbol), is preferred in the priority PRB set of the serving cell.

According to the first embodiment of the invention the priority PRB set is predefined and derived implicitly by each cell based on the link direction, subframe index, cell-ID, estimated cell load, or a similar factor. The base station allocates different priority PRB sets for cells with a different link direction. For PRBs in each priority PRB set, the priority order is also predefined, for example by ascending with the PRB index for the UL flexible subframe, and/or descending with the PRB index for the DL flexible subframe. According to an embodiment the priority order is linked to a radio frame index to achieve time-diversity gain.

An example of the first embodiment is illustrated in FIG. 4. A different priority PRB set pattern is adopted for UL and DL subframes. In a flexible subframe, the UL cell and the DL cell will use different PRBs for transmission from/to cell-edge user equipments to avoid or reduce interference. The priority PRB set varies with time to increase frequency diversity.

Another example is illustrated in FIG. 5, comprising four predefined priority PRB set patterns. Set 1 and 2 are for the UL subframe, while sets 3 and are for the DL subframe. For the cell setting one subframe as UL, selection is made based on its cell-ID to use set 1 or 2; the cell setting the same subframe as DL selects using set 3 or 4 based on the cell-ID. An example of the selection function:

Si=f(link_direction)*(g(cell-ID)*S1+(1−g(cell-ID))*S2)+(1−f(link_direction))*g(cell-ID)*S3+(1−g(cell-ID))*S4);

Where S1, S2, S3 and S4 denote the four defined priority PRB sets with a predefined priority order; f(link_direction)=1, if link direction is UL; otherwise 0; g(cell-ID)=0, if cell-ID is an even number, otherwise 1;

The first embodiment does not require signalling exchange between eNBs, and may be an implementation function enabled in each eNB during the network deployment. The embodiment is particularly suitable for the scenarios where no X2 interface is available between eNBs. It enables one to change the priority PRB per flexible subframe to get frequency diversity since the priority PRB set is a function of the subframe index. There is still the flexibility to let other cells reuse part of this resource with the priority order information selecting those PRBs with less possibility to be occupied, although a set of PRBs is reserved for each cell with predefinition.

According to the second embodiment the priority PRB set is derived from HII/RNTP indication, which is exchanged between eNBs. The HII indicates the PRBs where the eNB is going to schedule cell edge user equipments in the UL flexible subframe. The RNTP indicates the PRBs where a power setting lower than a threshold is guaranteed in the UL flexible subframe. One cell assumes the PRBs indicated by RNTP by neighbouring cells as the priority PRB set for a flexible subframe, while the UL cell will assume the PRBs marked as HIT by itself as the priority PRB set for a flexible subframe. This embodiment determines the priority PRB set for the flexible subframe based on eNB coordination requiring minimum signalling. The embodiment may be implemented with the signalling known in the state of the art, according to the current specification.

An example of the second embodiment is illustrated in FIG. 6. In the example the bandwidth is 25 PRBs. Cell#1 configures the flexible subframe 3, as UL, sends HII to cell#2 and cell#3 to indicate the high interference PRB set being 1-6; cell#2 configures the flexible subframe 3 as UL, then sends HII to cell#3 and cell#1 to indicate the high interference PRB set being 11-20.

In the flexible subframe 3-4, cell#1 will use PRB 1-6 as the priority PRB set, while cell#2 will use PRB 11-20 as the priority PRB set for the subframe 3 and use PRB 7-25 as the priority PRB set in the subframe 4. Cell#3 uses the subframe 1-10, 21-25 as the priority PRB set for the subframe 3-4. If one cell has multiple neighbouring cells, it has to determine the priority PRB set based on multiple cell's HII/RNTP.

According to the third embodiment a priority PRB indication signalling indicates the PRBs reserved for the flexible UL subframe and the priority order of these PRBs. The indicated PRBs are assumed to be the priority PRB set Si for that UL cell, and if there is not enough traffic to occupy all the PRBs in Si, the eNB will schedule the PRBs with the high priority first. The neighbouring DL cell will get the priority PRB set for DL transmission as Sk=S−Si; where S denotes the whole system bandwidth. In case Sk is not enough for the DL transmission, the DL cell selects some PRBs from Si, e.g, the PRBs with the lowest priority in Si. The priority order improves the resource efficiency.

The third embodiment utilizes signalling for the priority PRB indication, and has the advantage of making the reserved PRBs adapt to traffic or providing more details on the priority order of the reserved PRBs and assisting the neighbouring cell to choose which PRBs to use. The signalling may be sent via X2 or OTAC between eNBs. Since PRBs outside the priority PRB set can still be used for the cell-centre user equipment's UL or DMRS based DL, the invention maintains high spectrum efficiency.

According to the third embodiment cell#1 sends a new signalling to cell#2 and cell#3 to indicate that the PRB 1-6 are reserved for its UL, and the priority order of these PRBs decreases with the PRB index. Cell#2 configures the flexible subframe 3 as UL and sends signalling to cell#3 and cell#1 to indicate that the reserved PRB is 11-20 with increasing priority order. In the flexible subframe 3-4, cell#1 uses PRB 1-6 as the priority PRB set, while cell#2 uses PRB 11-20 as the priority PRB set for the subframe 3 and PRB 7-25 as the priority PRB set in the subframe 4. For cell#3, the subframes 1-10, 21-25 are used as the priority PRB set for the subframe 3-4, assuming cell#2 as the neighbouring cell. If additional resources are needed for transmission, they may be borrowed from 11-20 PRBs, starting from the PRB with a low priority which is PRB #11.

When scheduling user equipments in its cell, the eNB can take this priority PRB set into account. As an example the eNB gets an estimate on the user equipment position based on RSRP/RSRQ. The eNB generates a subframe-specific and PRB-specific scheduling priority factor for user equipments, based on the user equipment position, Priority PRB set for the cell, and link direction in the flexible subframe.

An example is illustrated in FIG. 7. The PRB set I is the priority PRB set for the UL cell, whereas the PRB set II is the priority PRB set for the DL cell. According to the priority factor, cell-edge UL user equipments are only allowed to be scheduled in the PRB set I in the UL flexible subframe, while cell-edge DL user equipments are only allowed to be scheduled in the PRB set II in flexible DL subframes. In fixed subframes, cell-edge user equipments have a higher priority than cell-centre user equipments. The priority scheduling factor generated in this table can be for example multiplied with the proportional fair (PF) factor resulted from the PF scheduling.

For a cell set having the subframe as DL transmission, the resource to be scheduled may be adjusted to a single user equipment's data transmission based on the priority PRB set in its own cell and neighbouring cells. However, the CRS, if configured, spreads into the whole band, but the interference can be reduced by another method, e.g, by setting the subframe as MBSFN subframes (MBSFN, multicast/broadcast single frequency network).

Embodiments of the present invention may be implemented in software, hardware, application logic or a combination of software, hardware and application logic. In an example embodiment, the application logic, software or instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer. The exemplary embodiments can store information relating to various processes described herein. This information can be stored in one or more memories, such as a hard disk, optical disk, magneto-optical disk, RAM, and the like. One or more databases can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases.

All or a portion of the exemplary embodiments can be conveniently implemented using one or more general purpose processors, microprocessors, digital signal processors, micro-controllers, and the like, programmed according to the teachings of the exemplary embodiments of the present inventions, as will be appreciated by those skilled in the computer and/or software art(s). Appropriate software can be readily prepared by programmers of ordinary skill based on the teachings of the exemplary embodiments, as will be appreciated by those skilled in the software art. In addition, the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware and/or software.

If desired, the different functions discussed herein may be performed in a different order and/or concurrently with each other.

Furthermore, if desired, one or more of the above-described functions may be optional or may be combined. Although various aspects of the invention are set out in the independent claims, other aspects of the invention comprise other combinations of features from the described embodiments and/or the dependent claims with the features of the independent claims, and not solely the combinations explicitly set out in the claims.

It is obvious to a person skilled in the art that with the advancement of technology, the basic idea of the invention may be implemented in various ways. The invention and its embodiments are thus not limited to the examples described above; instead they may vary within the scope of the claims.

1. A method, characterized by:
detecting interference in a subframe of a time division duplex configuration;
assigning a parameter indicating the interference in the subframe of the time division duplex configuration; and
transmitting said parameter to a network element.

2. The method according to claim 1, characterized by the parameter indicating cross-link interference from a neighbouring cell.

3. The method according to claim 2, characterized by the parameter indicating an interfered Physical Resource Block.

4. The method according to claim 2, characterized by the parameter being specified according to a subframe.

5. The method according to claim 1, characterized by the parameter indicating the detected interfered subframe.

6. The method according to claim 5, characterized by the subframe being related to the Physical Resource Block indicated by an Uplink Interference Overload Indication or an Uplink High Interference Indicator.

7. The method according to claim 1, characterized by the parameter indicating a subframe or frequency resource that allows changing the link direction.

8. The method according to claim 7, characterized by broadcasting said parameter.

9. The method according to claim 7, characterized by the parameter indicating the subframe index or the Physical resource Block index.

10. An apparatus for wireless communication, characterized by comprising at least one processor and at least one memory comprising program code, wherein the at least one memory and the computer program code are configured to, with the at least one processor, cause the apparatus to:
detect interference in a subframe of a time division duplex configuration;
assign a parameter indicating the interference in the subframe of the time division duplex configuration; and
transmit said parameter to a network element.

11. The apparatus for wireless communication according to claim 10, characterized by the parameter indicating cross-link interference from a neighbouring cell.

12. The apparatus for wireless communication according to claim 11, characterized by the parameter indicating an interfered Physical Resource Block.

13. The apparatus for wireless communication according to claim 11, characterized by the parameter being specified according to a subframe.

14. The apparatus for wireless communication according to claim 10, characterized by the parameter indicating the detected interfered subframe.

15. The apparatus for wireless communication according to claim 14, characterized by the subframe being related to the Physical Resource Block indicated by an Uplink Interference Overload Indication or an Uplink High Interference Indicator.

16. The apparatus for wireless communication according to claim 10, characterized by the parameter indicating a subframe or frequency resource that allows changing the link direction.

17. The apparatus for wireless communication according to claim 16, characterized by broadcasting said parameter.

18. The apparatus for wireless communication according to claim 16, characterized by the parameter indicating the subframe index or the Physical resource Block index.

19. A computer program product comprising a computer-readable medium bearing computer program code embodied therein for use with a computer, the computer program code comprising:
code for detecting interference in a subframe of a time division duplex configuration;
code for assigning a parameter indicating the interference in the subframe of the time division duplex configuration; and
code for transmitting said parameter to a network element.

20. The computer program product according to claim 19, characterized by the parameter indicating cross-link interference from a neighbouring cell.

21-27. (canceled)
